(19) United States
(12) Patent Application Publication
(10) Pub. No.: US 2023/0343976 A1
(43) Pub. Date: Oct. 26, 2023

(54) FUEL CELL DEVICE

(71) Applicant: MAGNA STEYR Fahrzeugtechnik GmbH & Co KG, Graz (AT)

(72) Inventor: Guido BARTLOK, Graz (AT)

(21) Appl. No.: 18/295,304

(22) Filed: Apr. 4, 2023

(30) Foreign Application Priority Data
Apr. 21, 2022 (DE) 102022203912.2

(51) Int. Cl. H01M 8/0662; H01M 8/04223; H01M 8/04082

(52) U.S. Cl. CPC H01M 8/0662; H01M 8/04208; H01M 8/04231; H01M 2250/20

(57) ABSTRACT

Fuel cell device for propulsion of a motor vehicle, and a method for operating the same. The fuel cell and a cryogenic tank storing liquid hydrogen, a boil-off management system keeping the pressure in the cryogenic tank below a threshold, the boil-off management system includes a boil-off conduit fluidically connected to the cryogenic tank via a boil-off valve. A mixing chamber is configured to mix a first medium flowing through the boil-off conduit with a second medium flowing in through the air feed conduit. A catalytic converter is connected downstream of the mixing chamber, and an outlet is connected downstream of the catalytic converter. A fuel cell off-gas tract, such that after anode purge operation of the fuel cell, off-gas is discharged through the fuel cell off-gas tract, which is configured such that medium flowing through the fuel cell off-gas tract can be conducted selectively and/or partially into the air feed conduit of the boil-off management system.

### CROSS-REFERENCE TO RELATED APPLICATIONS

The present application claims priority under 35 U.S.C. §119 to German Patent Application No. DE102022203912.2 (filed Apr. 21, 2022), the contents of which are hereby incorporated by reference in its entirety.

### TECHNICAL FIELD

The present disclosure relates to a fuel cell device for the propulsion of a motor vehicle, and to a method for operating a fuel cell device of said type.

### BACKGROUND

A fuel cell device for the propulsion of a motor vehicle may comprise a fuel cell that can convert hydrogen (H₂), as fuel of the fuel cell, together with an oxidant into electrical energy that is used for the propulsion of the motor vehicle. In order to store the hydrogen that is required for operating the fuel cell, such a motor vehicle may carry a cryogenic tank for storing supercooled gaseous and/or liquefied hydrogen, also referred to as “cryogenic tank” or “cryostatic container.”

Owing to the inevitable introduction of heat into the cryostatic container of a fuel cell vehicle that is operated with supercooled gaseous and/or liquid hydrogen, an evaporation and a change in density of hydrogen take place continuously. It is thus possible in turn for the temperature in the tank to be kept constant (so-called “boil-off”). In order to keep the pressure in the tank below a particular threshold value, a valve (so-called “boil-off valve” (BOV)) at said tank opens, whereby gaseous hydrogen is released into the surroundings. In order to eliminate a hazard (for example, ignition or explosion) resulting from excessively high hydrogen concentrations in the surroundings, the released gas can be catalytically reacted with the oxygen of the ambient air, and thus, reacts to form water vapour. This system is referred to as a “boil-off management system” (BMS). Since, during the operation of a hydrogen vehicle, an adequate quantity of gaseous hydrogen is always extracted or can always be extracted for operation, the BMS is required only after the vehicle has been at a standstill for a relatively long period of time, after the so-called “dormancy time.” As soon as (and only when) the boil-off valve opens, the outflow, the mixing with air and the catalytic reaction of the released hydrogen take place purely passively, i.e., without any action on the part of persons or further electronic or mechanical systems.

When the fuel cell system is started, but also at periodic intervals during operation, the anode or the anode circuit must be purged in order to purge the system of inert gas (nitrogen) that has diffused to the anode and/or of condensed water that has collected as a result of the reaction, and in order to remove same from the reaction surface. This operation (“purging”) occurs very frequently, and can be planned. Depending on the mode of operation, the purge operation may last for approximately a few seconds, and be repeated every 1 minute 40 minutes. The purging of the anode may be performed for example by virtue of the outlet valve for the hydrogen being opened for a few seconds in the presence of a set upstream pressure.

An air compressor provides the compressed air for the feed of oxygen that is required on the cathode side. For the post-processing after the operation of the fuel cell, a fuel cell system has a facility for supplying fresh air or a cathode off-gas mass flow in order to flush any reactants that are present (for example after the purge operation) out of the system and in order to eliminate combustible gas mixtures by dilution.

If the opening pressure of a boil-off valve is seldom reached, the BMS is consequently only seldom active, which can lead to passivation of the catalytic converter. Additional complex measures are then necessary to reactivate and/or maintain the functionality of a BMS.

### SUMMARY

It is an object of the disclosure to specify a fuel cell device for the propulsion of a motor vehicle, which fuel cell device avoids the above-stated problems and in particular, ensures, by simple and inexpensive means, the functionality of the boil-off management system of said fuel cell device even if the boil-off valve is not opened for relatively long periods of time. It is a further object of the disclosure to specify a method for operating a fuel cell device, which method ensures the functionality of the boil-off management system of said fuel cell device even if the boil-off valve is not opened for relatively long periods of time.

Said object is achieved by means of a fuel cell device for the propulsion of a motor vehicle, comprising a fuel cell and a cryogenic tank for storing supercooled gaseous and/or liquid hydrogen, furthermore comprising a boil-off management system (BMS) in order to keep the pressure in the cryogenic tank below a threshold value, wherein the boil-off management system comprises a boil-off conduit, which is fluidically connected to the cryogenic tank and which has a boil-off valve, and comprises an air feed conduit, and a mixing chamber for mixing the medium flowing in through the boil-off conduit with the medium flowing in through the air feed conduit, and a catalytic converter connected downstream of the mixing chamber, and an outlet connected downstream of the catalytic converter, wherein the fuel cell device furthermore comprises a fuel cell off-gas tract, wherein, after an anode purge operation of the fuel cell, off-gas is discharged through the fuel cell off-gas tract, wherein the fuel cell off-gas tract is configured such that medium flowing through the fuel cell off-gas tract can be conducted at least selectively and/or partially into the air feed conduit of the boil-off management system.

According to the disclosure, a fuel cell device of a motor vehicle has a boil-off management system which, in a manner known per se, has a catalytic converter and a mixing chamber upstream of the catalytic converter. In the mixing chamber, the medium flowing in through the boil-off conduit, which medium commonly has a high hydrogen content, can be mixed with air or oxygen that is fed to the mixing chamber via an air feed conduit.

According to the disclosure, the fuel cell device is now designed such that the boil-off management system is activated, preferably at regular intervals, even when no boil-off operation is necessary and it is therefore preferred for the boil-off valve not to be opened. For this purpose, a fuel cell off-gas tract that is present in any case, for the purposes of discharging off-gases in particular, after a purge operation of a fuel cell, is arranged such that medium flowing through the fuel cell off-gas tract, which medium preferably likewise has a high hydrogen content, is conducted at least selectively and/or partially into the air feed conduit of the boil-off management system.

The anode off-gas mass flow during a purge operation is preferably temporarily not diluted, or temporarily diluted only slightly, with fresh air or cathode off-gas mass flow. The consequently continuously hydrogen-enriched fuel cell off-gas mass flow is preferably introduced temporarily, and particularly preferably by means of a valve, for example a 3-way valve, to the air inlet of the BMS of the liquid hydrogen store, passes therein to the catalytic converter, and is exothermically reacted in the latter.

In this way, an increase in system efficiency and safety is achieved through functional integration and utilization of synergies between the hydrogen store system peripheral equipment (the BMS) and the fuel cell system.

Even if the opening pressure of the boil-off valve is seldom reached, the BMS is activated in this way, such that passivation of the catalytic converter is prevented and the functionality of the BMS is maintained.

A reduction in power of a fresh-air compressor for the purge operation can also be made possible in this way: During the purging of the fuel cell system, be it upon a commencement of operation, during operation or upon an ending of operation, the air compressor is often operated with particularly high power as a countermeasure. Said air compressor is then louder and reduces the system efficiency owing to its energy consumption. Through the use of the BMS after a purge operation, it is thus possible to achieve a cost saving and a lengthening of the compressor service life. Altogether, a simplification of the required countermeasures during a purge operation, and an increase in safety owing to the hydrogen reaction in the BMS, are achieved.

The anode off-gas is commonly merely diluted owing to the post-processing, and the absolute emissions of hydrogen are thus not reduced. This has an effect on the total hydrogen emissions and on a possible enrichment of hydrogen in the surroundings of the vehicle. The use of the BMS after a purge operation can thus also increase safety.

The expression “fuel cell” in a solution according to the disclosure may also be understood to mean a fuel cell system that may comprise multiple fuel cells. The fuel cell system then has the fuel cell off-gas tract.

Preferably, the fuel cell off-gas tract is configured such that medium flowing through the fuel cell off-gas tract can be conducted at least selectively and/or partially to an air inlet, in particular air inlet funnel, at the air feed conduit of the boil-off management system. The air inlet may be formed by an end of a pipe of the air feed conduit.

Preferably, the air inlet, in particular air inlet funnel, at the air feed conduit of the boil-off management system is configured such that, in addition to the medium flowing through the fuel cell off-gas tract, air or oxygen can also pass through the same air inlet, in particular the same air inlet funnel, at the air feed conduit of the boil-off management system.

There is no need for a sealed pipeline to be provided between the purging off-gas pipe, that is to say the fuel cell off-gas tract, and the air inlet or air inlet funnel of the BMS, such that, during the dissipation of positive pressure that is required to protect the tank container, with hydrogen passing via the boil-off valve and the “boil-off conduit” into the BMS, the oxygen required for the combustion of hydrogen that is then necessary can also flow into/via the air feed conduit of the BMS.

The connection for the inflow of the fuel cell purge off-gas in the region of the BMS air inlet is preferably implemented such that the BMS function of “drawing in fresh air” is not significantly impaired thereby.

Preferably, the fuel cell off-gas tract can be selectively fluidically connected by means of a three-way valve to the air feed conduit of the boil-off management system and to a fuel cell off-gas tract outlet.

Preferably, in the fuel cell device, there are provided mixing means for mixing an anode off-gas mass flow, which is discharged through the fuel cell off-gas tract after an anode purge operation of the fuel cell, with air and/or with a cathode off-gas mass flow, wherein the mixing means are configured such that an anode off-gas mass flow that is discharged through the fuel cell off-gas tract after an anode purge operation of the fuel cell is mixed to a lesser degree, or is not mixed at all, with air and/or with a cathode off-gas mass flow if said anode off-gas mass flow is conducted into the air feed conduit of the boil-off management system than if said anode off-gas mass flow is conducted to a fuel cell off-gas tract outlet.

The mixing means may in particular, comprise a control unit which, when the anode off-gas mass flow is conducted into the air feed conduit of the boil-off management system, mixes the anode off-gas mass flow to a lesser degree, or not at all, with air and/or with a cathode off-gas mass flow.

The mixing means may comprise a compressor for mixing the anode off-gas mass flow that is discharged through the fuel cell off-gas tract after an anode purge operation of the fuel cell with air and/or with a cathode off-gas mass flow, wherein, preferably, the compressor is operated to a lesser degree, or is not operated at all, if the anode off-gas mass flow is conducted into the air feed conduit of the boil-off management system than if said anode off-gas mass flow is conducted to a fuel cell off-gas tract outlet.

In a method according to the disclosure for operating a fuel cell device, after an anode purge operation of the fuel cell, off-gas is discharged through the fuel cell off-gas tract, wherein medium flowing through the fuel cell off-gas tract is conducted at least selectively and/or partially into the air feed conduit of the boil-off management system.

Preferably, medium flowing through the fuel cell off-gas tract is conducted at least partially into the air feed conduit of the boil-off management system at regular time intervals, such that the catalytic converter of the BOM is regularly activated.

Preferably, an anode off-gas mass flow that is discharged through the fuel cell off-gas tract after an anode purge operation of the fuel cell is mixed to a lesser degree, or is not mixed at all, with air and/or with a cathode off-gas mass flow if said anode off-gas mass flow is conducted into the air feed conduit of the boil-off management system than if said anode off-gas mass flow is conducted to a fuel cell off-gas tract outlet. Particularly preferably, a compressor is operated to a lesser degree, or is not operated at all, if the anode off-gas mass flow is conducted into the air feed conduit of the boil-off management system than if said anode off-gas mass flow is conducted to a fuel cell off-gas tract outlet.

### DRAWINGS

The disclosure will be described by way of example below with reference to the drawing. Like reference symbols in the various drawings may indicate like elements.

FIG. 1 shows a schematic view of a fuel cell device according to the disclosure.

### DESCRIPTION

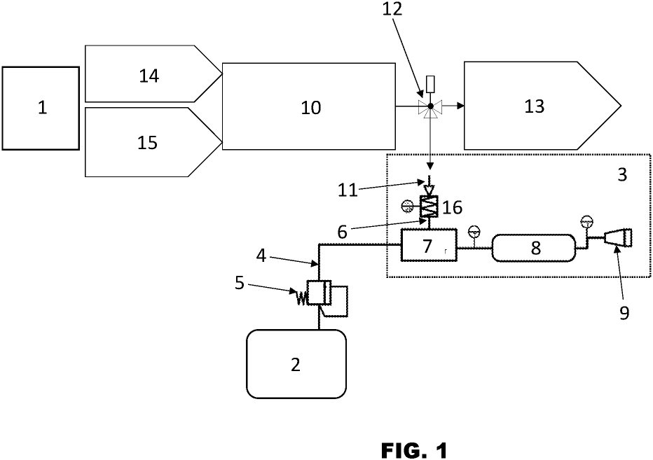

FIG. 1 illustrates a fuel cell device according to the disclosure that comprises a fuel cell, or a fuel cell system 1, and a cryogenic tank 2 for storing liquid hydrogen.

The cryogenic tank 2 comprises a boil-off management system 3 in order to keep the pressure in the cryogenic tank 2 below a threshold value, wherein the boil-off management system 3 comprises a boil-off conduit 4, which is fluidically connected to the cryogenic tank 2 and which has a boil-off valve 5, and comprises an air feed conduit 6, and a mixing chamber 7 for mixing the medium flowing in through the boil-off conduit 4 with the medium flowing in through the air feed conduit 6. The boil-off management system 3 furthermore comprises a catalytic converter 8 connected downstream of the mixing chamber 7, and an outlet 9 connected downstream of the catalytic converter 8.

The fuel cell or the fuel cell system 1 can, for example, be purged at regular intervals, wherein an anode off-gas mass flow 14, mixed with a cathode off-gas mass flow 15 and/or with air, is then conducted through a fuel cell off-gas tract 10 to a fuel cell off-gas tract outlet 13, and for example released into the surroundings at the fuel cell off-gas tract outlet 13.

The anode off-gas mass flow 14 may be formed by a fuel cell anode off-gas that has a high hydrogen content. The cathode off-gas mass flow 15 may be provided by a compressor and may contain oxygen. Hydrogen, atmospheric gases and/or water vapour, among others, may be present in the fuel cell off-gas tract 10.

The fuel cell off-gas tract 10 is configured such that medium flowing through the fuel cell off-gas tract 10 can be conducted selectively into the air feed conduit 6 of the boil-off management system 3, more specifically into an air inlet 11, in particular, air inlet funnel, of the air feed conduit 6 of the boil-off management system 3. The fuel cell off-gas tract 10 is selectively connectable by means of a three-way valve 12 to the air feed conduit 6 of the boil-off management system 3 and to the fuel cell off-gas tract outlet 13.

In addition to the medium flowing through the fuel cell off-gas tract 10, fresh air or oxygen can also pass through the same air inlet 11 at the air feed conduit 6 of the boil-off management system 3. An air filter 16 is optionally arranged in the air feed conduit 6.

The anode off-gas mass flow 14 that is discharged through the fuel cell off-gas tract 10 after an anode purge operation of the fuel cell or of the fuel cell system 1 can be mixed to a lesser degree, or not mixed at all, with air and/or with the cathode off-gas mass flow 15 if said anode off-gas mass flow is conducted into the air feed conduit 6 of the boil-off management system 3 than if said anode off-gas mass flow is conducted to a fuel cell off-gas tract outlet 13, because the hydrogen of the anode off-gas mass flow 14 is reacted in the catalytic converter 8 of the boil-off management system 3.

LIST OF REFERENCE SYMBOLS

| | |
|---|---|
| 1 | Fuel cell |
| 2 | Cryogenic tank |
| 3 | Boil-off management system |
| 4 | Boil-off conduit |
| 5 | Boil-off valve |
| 6 | Air feed conduit |
| 7 | Mixing chamber |
| 8 | Catalytic converter |
| 9 | Outlet |
| 10 | Fuel cell off-gas tract |
| 11 | Air inlet |
| 12 | Three-way valve |
| 13 | Fuel cell off-gas tract outlet |
| 14 | Anode off-gas mass flow |
| 15 | Cathode off-gas mass flow |
| 16 | Air filter |

What is claimed is:

1. A fuel cell device for the propulsion of a motor vehicle, the fuel cell device comprising:
a fuel cell;
a cryogenic tank for storing supercooled gaseous hydrogen and/or liquid hydrogen;
a boil-off management system to maintain the pressure in the cryogenic tank below a threshold value, the boil-off management system including:
a boil-off conduit having a via a boil-off valve fluidically connected to the cryogenic tank, and through which is received a first medium,
an air feed conduit through which is received a second medium,
a mixing chamber for mixing the first medium with the second medium,
a catalytic converter connected downstream of the mixing chamber, and
an outlet connected downstream of the catalytic converter;
a fuel cell off-gas tract configured such that after an anode purge operation of the fuel cell, off-gas is discharged therethrough, the fuel cell off-gas tract being further configured such that medium flowing therethrough is conducted at least selectively and/or partially into the air feed conduit.

2. The fuel cell device of claim 1, wherein the air feed conduit includes an air inlet funnel.

3. The fuel cell device of claim 2, wherein the fuel cell off-gas tract is configured such that medium flowing therethrough is conducted at least selectively and/or partially to the air inlet funnel.

4. The fuel cell device of claim 2, wherein the air inlet funnel is configured such that air or oxygen flows therethrough.

5. The fuel cell device of claim 1, further comprising a three-way valve configured to selectively fluidically connect the fuel cell off-gas tract to the air feed conduit and to a fuel cell off-gas tract outlet.

6. The fuel cell device of claim 1, wherein the fuel cell device is configured to mix an anode off-gas mass flow, which is discharged through the fuel cell off-gas tract after an anode purge operation of the fuel cell, with air and/or with a cathode off-gas mass flow.

7. The fuel cell device of claim 1, wherein the fuel cell device is configured such that an anode off-gas mass flow that is discharged through the fuel cell off-gas tract after an anode purge operation of the fuel cell is mixed to with air and/or with a cathode off-gas mass flow when said anode off-gas mass flow is conducted into the air feed conduit.

8. The fuel cell device of claim 1, further comprising a compressor for mixing the anode off-gas mass flow that is discharged through the fuel cell off-gas tract after an anode purge operation of the fuel cell with air and/or with a cathode off-gas mass flow.

9. The fuel cell device of claim 8, wherein the compressor is operated to a lesser degree, when the anode off-gas mass flow is conducted into the air feed conduit of the boil-off management system.

10. A method for operating a fuel cell device of claim 1, the method comprising:
discharging, after an anode purge operation of the fuel cell, off-gas through the fuel cell off-gas tract; and
selectively and/or partially conducting the medium flowing through the fuel cell off-gas tract at least into the air feed conduit.

11. The method of claim 10, wherein the medium flowing through the fuel cell off-gas tract at least into the air feed conduit is selectively and/or partially conducted at regular time intervals.

12. The method of claim 10, further comprising, after an anode purge operation of the fuel cell, mixing an anode off-gas mass flow that is discharged through the fuel cell off-gas tract with air and/or with a cathode off-gas mass flow when said anode off-gas mass flow is conducted into the air feed conduit.

13. The method of claim 10, further comprising, after an anode purge operation of the fuel cell, operating a compressor is operated to a lesser degree, when the anode off-gas mass flow is conducted into the air feed conduit.
